(19) United States
(12) Patent Application Publication
(10) Pub. No.: US 2009/0283976 A1
(43) Pub. Date: Nov. 19, 2009

(54) SUBSTRATE HOLDING APPARATUS

(75) Inventors: Kazuaki Kaneko, Fuchu-shi (JP); Yoh Tanaka, Fuchu-shi (JP); Masayoshi Ikeda, Hachioji-shi (JP); Yohsuke Shibuya, Hino-shi (JP)

Correspondence Address: FITZPATRICK CELLA HARPER & SCINTO, 1290 Avenue of the Americas, NEW YORK, NY, 10104-3800, US

(73) Assignee: CANON ANELVA CORPORATION, Kawasaki-shi (JP)

(21) Appl. No.: 12/432,098

(22) Filed: Apr. 29, 2009

(30) Foreign Application Priority Data
May 16, 2008 (JP) 2008-129118
Feb. 20, 2009 (JP) 2009-038453

(51) Int. Cl. B23Q 3/15; B23Q 3/00

(52) U.S. Cl. 279/128; 279/142

(57) ABSTRACT

A substrate holding apparatus comprises a substrate holding mechanism configured to hold a substrate; a heating mechanism; and a heat-conductive member which is interposed between the substrate holding mechanism and the heating mechanism to be in contact therewith and conducts heat generated by the heating mechanism to the substrate holding mechanism, wherein the heat-conductive member has a recessed section that opens to the substrate.

### BACKGROUND OF THE INVENTION

1. Field of the Invention

The present invention relates to a substrate holding apparatus which controls a substrate temperature uniformly.

2. Description of the Related Art

In recent years, the integration density degree becomes high in the semiconductor manufacture. For higher integrated circuit productivity, the substrate temperature must be controlled accurately and uniformly with good reproducibility.

For example, in aluminum (Al) thin film formation by sputtering, to bury Al in micropores, the process is performed in a temperature range of 400° C. to 500° C. In order to bury Al in the micropores in this temperature range without forming voids, accurate, uniform temperature control is required.

When forming a tungsten (W) film or titanium nitride (TiN) film on a substrate by CVD, the process is performed in a temperature range of 300° C. to 600° C. In this case as well, accurate, uniform substrate temperature control is an important factor in determining various properties of the thin film such as electrical characteristics and film thickness distribution. As the substrate diameter increases, it is more important to uniform the substrate temperature for maintaining and improving the yield.

As a technique associated with this issue, for example, Japanese Patent Laid-Open No. 2000-299288 describes a plasma processing apparatus. In this apparatus, a stage heated by a resistive heater is thermally coupled to a cooling jacket via a heat-conductive sheet. Heat from the stage is dissipated outside the chamber via the cooling jacket. Japanese Patent Laid-Open No. 2000-299371 describes an electrostatic chuck device provided with a transformable sheet between an electrostatic chuck and cooling base.

Even with the conventional technique described above, it is difficult to control the substrate temperature accurately and uniformly. In particular, in a substrate holding apparatus including a heating mechanism, thermal strain may occur upon heating and decrease the adhesion among the substrate holding mechanism, heat-conductive member, and heating mechanism. Then, the substrate temperature cannot be maintained accurately and uniformly.

### SUMMARY OF THE INVENTION

The present invention has been made in consideration of the aforementioned problems, and attains a substrate holding apparatus which can control the substrate temperature accurately and uniformly.

In order to solve the aforementioned problems, there is provided a substrate holding apparatus comprises a substrate holding mechanism configured to hold a substrate; a heating mechanism; and a heat-conductive member which is interposed between the substrate holding mechanism and the heating mechanism to be in contact therewith and conducts heat generated by the heating mechanism to the substrate holding mechanism, wherein the heat-conductive member has a recessed section that opens to the substrate.

According to the present invention, the heat-conductive member interposing between the substrate holding mechanism and heating mechanism has a recessed section. Even if the heating mechanism strains thermally, the adhesion among the heating mechanism, heat-conductive member, and substrate holding mechanism can be maintained. Hence, the substrate temperature can be controlled accurately and uniformly.

Further features of the present invention will become apparent from the following description of exemplary embodiments with reference to the attached drawings.

### BRIEF DESCRIPTION OF THE DRAWINGS

FIG. 1 shows the arrangement of a substrate holding apparatus according to an embodiment of the present invention;

FIG. 2A is a plan view showing a heat-conductive sheet of the embodiment;

FIG. 2B is a sectional view taken along the line i-i of FIG. 2A;

FIG. 3A is a view showing the unheated state of a heat-conductive sheet as a comparative example;

FIG. 3B is a view showing the heated state of the heat-conductive sheet as the comparative example;

FIG. 4A is a view showing the unheated state of a heat-conductive sheet of the embodiment;

FIG. 4B is a view showing the heated state of the heat-conductive sheet of the embodiment;

FIG. 5 is a view showing the layout of leaf springs at the outer peripheral portion of an electrostatic chucking plate of the embodiment;

FIG. 6 is a sectional view showing the leaf spring of the embodiment;

FIG. 7A is a plan view showing a heat-conductive sheet of an embodiment;

FIG. 7B is a sectional view taken along the line ii-ii of FIG. 7A;

FIG. 8 is a view showing the arrangement of a substrate holding apparatus employed in the experiment of an embodiment;

FIG. 9 is a graph showing the substrate temperature distribution under respective experimental conditions;

FIG. 10 is an enlarged view of a gas channel formed in the heat-conductive sheet shown in FIG. 4A;

FIG. 11A is a plan view of a microbellows; and

FIG. 11B is a side view of the microbellows.

### DESCRIPTION OF THE EMBODIMENTS

Embodiments to practice the present invention will be described hereinafter in detail with reference to the accompanying drawings. Note that the embodiments to be described hereinafter are merely examples to implement the present invention and should be corrected or modified where needed depending on the arrangement and various conditions of the apparatus to which the present invention is applied, and that the present invention is not limited to the following embodiments.

[Arrangement of Apparatus]

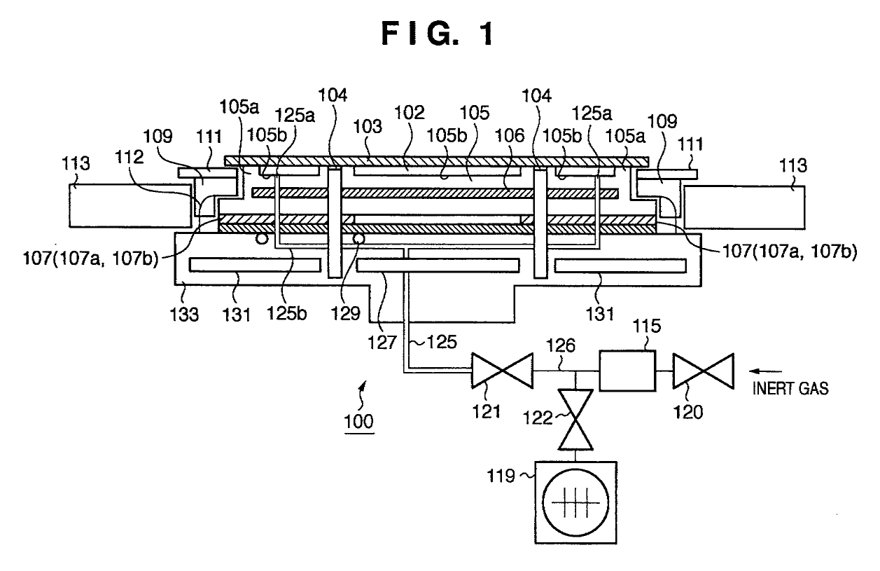

The overall arrangement of a substrate holding apparatus 100 according to an embodiment of the present invention will be described with reference to FIG. 1. FIG. 1 is a view showing the arrangement of the substrate holding apparatus according to the embodiment of the present invention. As shown in FIG. 1, the substrate holding apparatus 100 includes a substrate holding mechanism 105 for holding a substrate 103, a heating mechanism 133 disposed under the substrate holding mechanism 105, and a heat-conductive member 107 interposing between the substrate holding mechanism 105 and heating mechanism 133.

The substrate holding mechanism 105 forms an electrostatic chucking plate (electrostatic chuck) on which the substrate 103 is placed and held by chucking with an electrostatic force (attracting force). The upper surface of the electrostatic chucking plate 105 where the substrate 103 is to be placed has projections 105a and recessed grooves 105b. The substrate 103 is placed on the projection 105a of the electrostatic chucking plate 105 to be in contact with it. The recessed groove 105b forms a predetermined space 102 between the substrate 103 and electrostatic chucking plate 105. A plurality of gas outlets (on the outer peripheral side) 125a communicating with a gas channel 125b open to the bottom surface of the recessed groove 105b of the electrostatic chucking plate 105. Thus, an inert gas (e.g., Ar) is supplied to and circulated in the substrate 103 and controls its temperature. The recessed groove 105b and gas channel 125b are formed on the outer peripheral side and/or center of the electrostatic chucking plate 105.

Lift pins 104 which can support the substrate 103 and move it vertically are arranged in the substrate holding mechanism 105. When transporting the substrate 103, a gap through which a transport robot (not shown) transports the substrate 103 lifted by the lift pins 104 can be formed in the substrate holding mechanism 105.

In this embodiment, the electrostatic chucking plate 105 employs a single-pole chucking method. The substrate holding mechanism 105 forms a disk-like dielectric plate and incorporates a single electrode portion 106. According to the single pole chucking method, the electrode portion 106 is electrically connected to an electrostatic chucking DC power supply (not shown) which applies an electrostatic chucking DC voltage to it via a conductor rod (not shown), so that the electrode portion 106 receives a positive or negative voltage having a predetermined voltage value. The electrostatic chucking plate 105 is made of a dielectric material such as a ceramic material. Upon application of the voltage, the electrode portion 106 generates electrostatic force to hold the substrate 103 by electrostatic chucking. In this embodiment, the chucking method of the electrostatic chucking plate 105 is not limited to the single pole method, but a bipolar electrostatic chuck may be employed instead.

An almost annular silica ring member 109 is disposed to surround the outer side surface of the electrostatic chucking plate 105. The silica ring member 109 sets a shield 111 in a floating state. Furthermore, a chamber shield 113 is disposed to surround the outer side surface of the silica ring member 109. The shield 111 serving as a floating potential is formed on the upper surface of the silica ring member 109.

A heat-conductive sheet serving as the sheet type heat-conductive member (to be referred to as the heat-conductive sheet hereinafter) 107 is mounted on the lower surface of the electrostatic chucking plate 105 to be in contact with it. The heater unit 133 serving as the heating mechanism is disposed on the lower surface of the heat-conductive sheet 107 to be in contact with it. Heaters 127 and 131 to heat the substrate 103 are arranged in the heater unit 133. The heat-conductive sheet 107 has a function of conducting heat generated by the heater unit 133 to the electrostatic chucking plate 105 efficiently.

Leaf springs 112 serving as locking members (to be described later) fix the outer edge of the electrostatic chucking plate 105 to the heater unit 133.

In the heater unit 133, a plurality of thermocouples 129 to detect the interface temperature of the heater unit 133 on the substrate 103 side are arranged above the heaters 127 and 131 over the entire surface of the heater unit 133.

[Heat-Conductive Sheet]

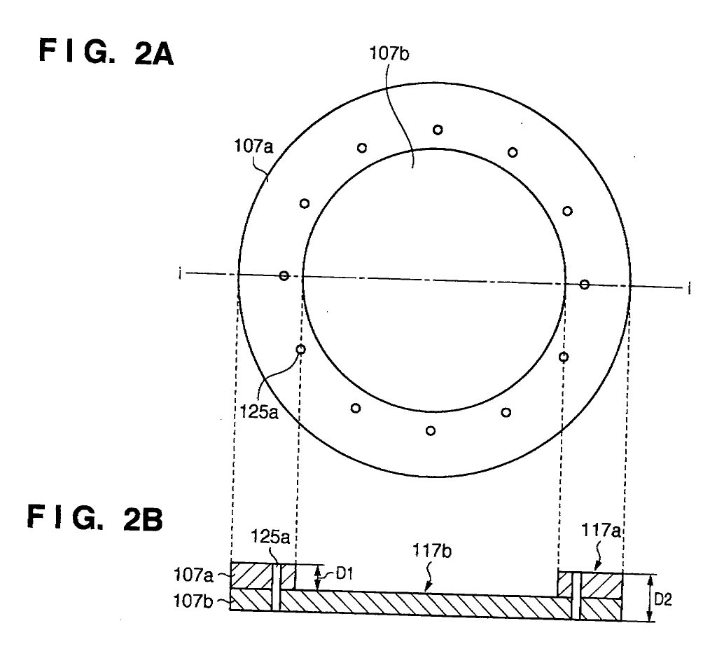

The shape of the heat-conductive sheet 107 will be described hereinafter in detail with reference to FIGS. 2A and 2B. FIG. 2A is a plan view showing the heat-conductive sheet of the embodiment, and FIG. 2B is a sectional view taken along the line i-i of FIG. 2A. As shown in FIG. 2A, the heat-conductive sheet 107 is formed by stacking a ring-like heat-conductive sheet portion 107a on the outer peripheral portion of the upper surface of a disk-like heat-conductive sheet 107b. Thus, a projection 117a is formed on the outer peripheral portion of the upper surface of the heat-conductive sheet 107, and a recess 117b is formed on the inner peripheral portion of the upper surface of the heat-conductive sheet 107. The outer shape of the heat-conductive sheet 107 is not limited to a circular one, but can be a polygonal one such as a square or pentagonal one.

The ring-like heat-conductive sheet portion 107a is preferably made of an elastic heat-conductive material. As the elastic heat-conductive material, for example, carbon, rubber mixed with a high-heat-conductive material such as a metal (copper, silver, an alloy, or the like), or sponge can be employed.

As the disk-like heat-conductive sheet 107b, a sheet-, plate-, or foil-like member made of a heat-conductive material can be employed. As the disk-like heat-conductive sheet 107b, for example, a carbon sheet, aluminum nitride sheet, carbon-containing rubber sheet, or carbon-containing sponge sheet can be used. The carbon sheet is formed by molding to contain graphite, and is fabricated by processing graphite with an acid to obtain expanded graphite, and rolling the expanded graphite into a sheet.

The projection 117a and recess 117b of the heat-conductive sheet 107 may be formed integrally by molding, or by adhesion using an adhesive or the like.

The gas channel 125b serving as an inert gas channel is formed to extend through a portion where the disk-like heat-conductive sheet 107b and ring-like heat-conductive sheet portion 107a stack.

As shown in FIG. 2B as well, the heat-conductive sheet 107 has the projection 117a on its outer peripheral portion and the recess 117b on its inner peripheral portion. More specifically, the projection 117a at the outer peripheral portion of the heat-conductive sheet 107 is formed by stacking the ring-like heat-conductive sheet portion 107a on the disk-like heat-conductive sheet 107b, and is in contact with the lower surface of the electrostatic chucking plate 105. The recess 117b at the inner peripheral portion of the heat-conductive sheet 107 forms a gap not overlapping the ring-like heat-conductive sheet portion 107a and not in contact with the electrostatic chucking plate 105.

In this embodiment, the heat-conductive sheet 107 is circular simply because the substrate 103 and electrostatic chucking plate 105 are circular, and can be rectangular or elliptic.

As described above, the gas channel 125b formed in the heat-conductive sheet 107 communicates with the gas outlets (on the outer peripheral side) 125a of the electrostatic chucking plate 105. In FIG. 2B, the projection 117a of the heat-conductive sheet 107 preferably has a thickness D1 of, for example, 0.2 mm to 0.6 mm, and the heat-conductive sheet 107 preferably has an entire thickness D2 of, for example, 2 mm or less.

[Function of Heat-Conductive Sheet]

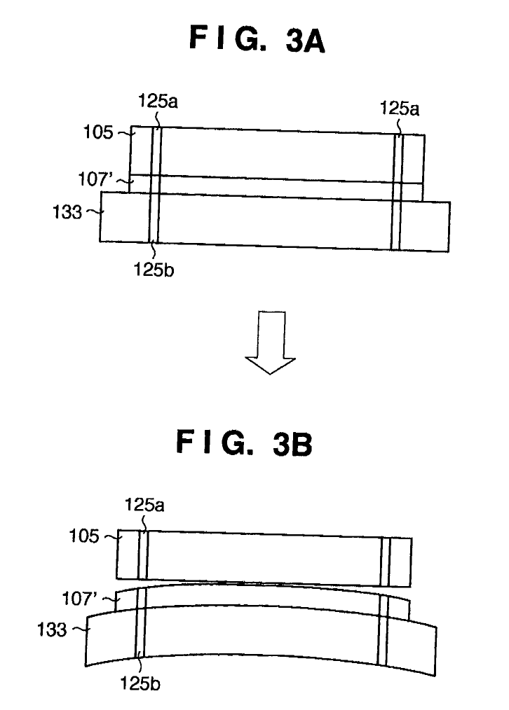

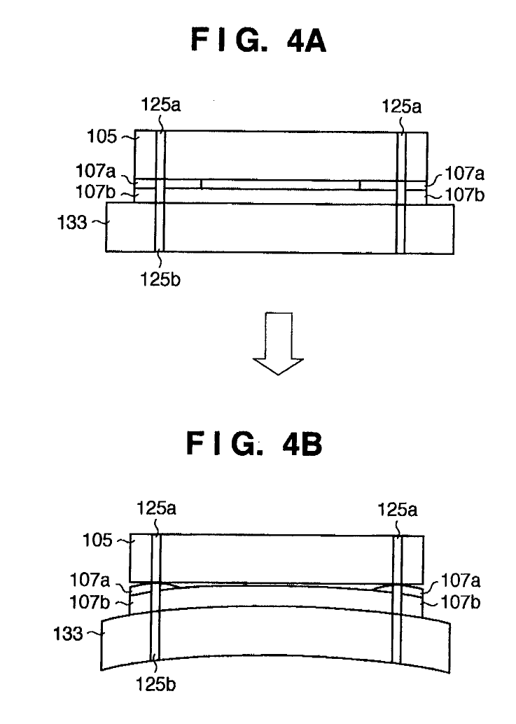

The reason for forming the outer and inner peripheral portions of the upper surface of the heat-conductive sheet 107 into the projection and recess, respectively, will be described with reference to FIGS. 3A and 3B, and FIGS. 4A and 4B. FIG. 3A is a view showing the unheated state of a heat-conductive sheet as a comparative example, and FIG. 3B is a view showing the heated state of the heat-conductive sheet as the comparative example. FIG. 4A is a view showing the unheated state of a heat-conductive sheet of the embodiment, and FIG. 4B is a view showing the heated state of the heat-conductive sheet of the embodiment.

In the comparative example shown in FIG. 3A, a heat-conductive sheet 107′ forms a disk and is flat so that it comes into contact with the lower surface of the electrostatic chucking plate 105 throughout the entire surface. The intensive studies conducted by the present inventor proved that, as shown in FIG. 3B, the temperature difference between heating and non-heating caused projecting distortion in the heater unit 133 on the contact interface of the electrostatic chucking plate 105 and heat-conductive sheet 107′. Namely, the thermal strain of the heater unit 133 left on the outer peripheral portion of the heat-conductive sheet 107′ a portion that was not in contact with the electrostatic chucking plate 105. Because of this, heat did not conduct uniformly from the heat-conductive sheet 107′ to the electrostatic chucking plate 105, making the temperature distribution of the substrate 103 nonuniform. Also, the thermal strain of the heater unit 133 caused gas leakage from the gas channel 125b formed in the outer peripheral portion of the heat-conductive sheet 107′.

In view of this, according to this embodiment, as shown in FIG. 4A, to compensate for the non-contact portion formed by the thermal strain of the heater unit 133, the outer peripheral portion of the upper surface of the heat-conductive sheet 107 forms a projection, so that the heat-conductive sheet 107 is recessed as a whole. Thus, as shown in FIG. 4B, even when the heater unit 133 generates heat, both the projection 117a and recess 117b on the outer and inner peripheral portions, respectively, of the heat-conductive sheet 107 keep in contact with the electrostatic chucking plate 105, so that the substrate 103 has a uniform temperature distribution.

Furthermore, the gas channel 125b is formed to extend through the projection 117a on the outer peripheral portion of the heat-conductive sheet 107 sandwiched between the electrostatic chucking plate 105 and heater unit 133. This can prevent gas leakage resulting from thermal strain (see FIG. 4B). In other words, even when the heat-conductive sheet 107 deforms elastically and thermal strain occurs, the projection 117a on the outer peripheral portion of the heat-conductive sheet 107 keeps in contact with the lower surface of the electrostatic chucking plate 105.

The heat-conductive sheet 107 need not always be formed of two sheets, that is, the disk-like heat-conductive sheet 107b and ring-like heat-conductive sheet portion 107a, but can be formed as a single sheet member integrally molded to have a recess on the inner peripheral portion of a sheet.

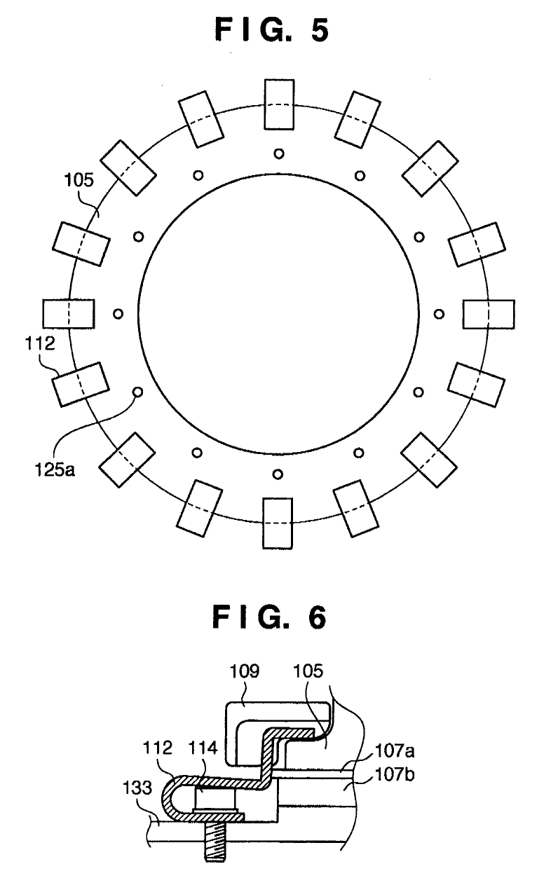

FIG. 5 is a view showing locking members to fix the outer peripheral portion of the electrostatic chucking plate of the embodiment to the heater unit. FIG. 6 is a sectional view showing the locking member of the embodiment.

As shown in FIGS. 5 and 6, the plurality of elastic locking members is radially arranged on the outer peripheral portion of the electrostatic chucking plate 105. Each locking member is formed of the leaf spring 112 and a screw 114. One end of the leaf spring 112 locks the outer edge of the electrostatic chucking plate 105, and the screw 114 fixes the other end of the leaf spring 112, thus holding the electrostatic chucking plate 105. The leaf springs 112 are arranged on the electrostatic chucking plate 105 at equal intervals in the circumferential direction, and their intervals are preferably 50 mm or less. This adheres the electrostatic chucking plate 105 and the heater unit 133 more tightly, so that the temperature of the substrate 103 can be controlled more uniformly.

As described above, the gas outlets 125a extend through the electrostatic chucking plate 105, heat-conductive sheet portions 107a and 107b, and heater unit 133, and are connected to a gas pipe 125 extending outside the substrate holding apparatus. The gas outlets 125a are disposed evenly on a close-circumference with a P.C.D. (Pitch Circle Diameter) falling within a range of 240 mm±10 mm. The interval between the adjacent gas outlets 125a is 70 mm or less. The number of gas outlets 125a is 12 to 24. Each gas outlet 125a has an opening diameter of 0.5 mm to 1.5 mm.

Referring back to FIG. 1, the gas outlets 125a are connected to an Ar gas source (not shown) via an air operation valve 121, a pressure control valve 115 to adjust the gas pressure on the substrate lower surface, and an air operation valve 120 in this order from the downstream side. A gas pipe 126 between the air operation valves 121 and 120 is connected to an exhaust pump 119 to exhaust the gas under the substrate lower surface or in the chamber via an exhaust control valve 122.

### Other Embodiments

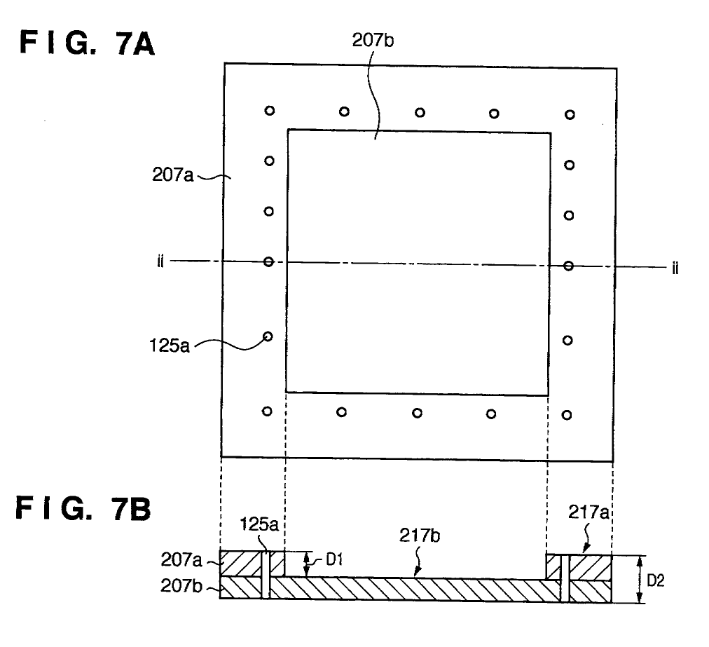

A heat-conductive sheet according to another embodiment will be described hereinafter with reference to FIGS. 7A and 7B. FIG. 7A is a plan view showing a heat-conductive sheet according to another embodiment of the present invention, and FIG. 7B is a sectional view taken along the line ii-ii of FIG. 7A. As shown in FIG. 7A, a heat-conducive sheet 207 is employed when a substrate 103, electrostatic chucking plate 105, and the like are rectangular. The heat-conducive sheet 207 is formed by stacking a frame-like heat-conductive sheet portion 207a on a rectangular heat-conductive sheet portion 207b. The frame-like heat-conductive sheet portion 207a is formed by rectangularly removing the center of the rectangular heat-conductive sheet portion 207b.

As shown in FIG. 7B, when observing the section of the heat-conducive sheet 207, a projection 217a and recess 217b are formed on the outer and inner peripheral portions, respectively, of the heat-conducive sheet 207, so that the heat-conducive sheet 207 has a recess as a whole. Hence, in the same manner as the heat-conductive sheet 107 described above, when a heater unit 133 generates heat, both the projection 217a and recess 217b on the outer and inner peripheral portions, respectively, of the heat-conductive sheet 207 keep in contact with the electrostatic chucking plate 105, so that the substrate 103 has a uniform temperature.

Furthermore, a gas channel 125b is formed to extend through the projection 217a on the outer peripheral portion of the heat-conductive sheet 207 sandwiched between the electrostatic chucking plate 105 and heater unit 133. This can prevent gas leakage resulting from thermal strain as well.

According to the respective embodiments described above, the sectional shape of each of the heat-conductive sheets 107 and 207 has a recess that opens to the substrate side as a whole. This can maintain the heater unit 133, heat-conductive sheet 107 or 207, and electrostatic chucking plate 105 in tight contact with each other even when the heater unit 133 generates heat. This allows controlling the temperature of the substrate 103 accurately and uniformly.

As the gas channel is formed in the projection 117a or 217a on the outer peripheral portion of the heat-conductive sheet 107 or 207 sandwiched between the electrostatic chucking plate 105 and heater unit 133, leakage of an inert gas supplied to the lower surface of the substrate 103 can be prevented.

### Example

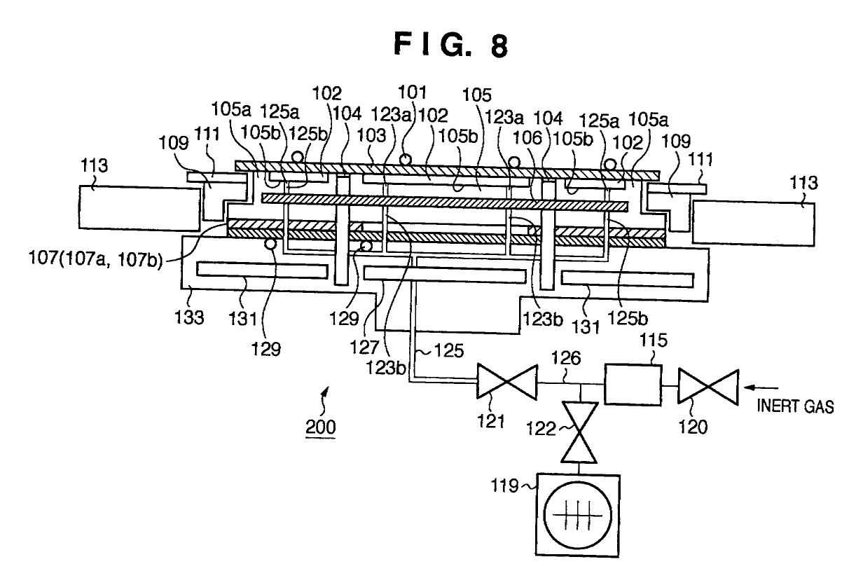

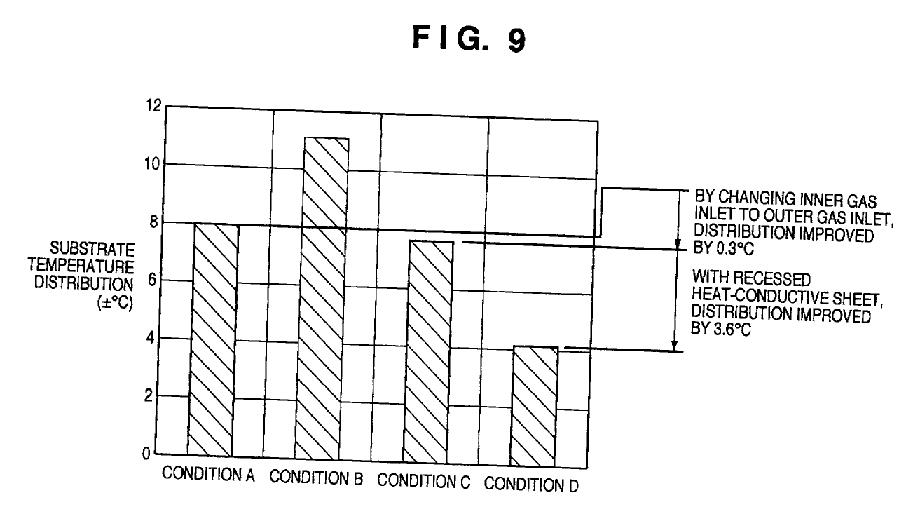

An experimental result on the substrate temperature distribution obtained using a substrate holding apparatus according to an embodiment of the present invention will be described with reference to FIGS. 8 and 9.

FIG. 8 is a view showing the arrangement of a substrate holding apparatus 200 according to the embodiment. In the following description, the same constituent members as those in FIG. 1 are denoted by the same reference numerals, and a repetitive description will be omitted.

As shown in FIG. 8, the substrate holding apparatus 200 is provided with gas outlets (on the inner peripheral side) 123a communicating with a space 102 at the center of the lower surface of a substrate 103, in addition to gas outlets 125a identical to those of the substrate holding apparatus 100 shown in FIG. 1. A plurality of thermocouples 101 to detect the substrate temperature is arranged on the entire surface of the substrate 103.

FIG. 9 is a graph showing the experimental result of the substrate holding apparatus 200 of this embodiment under conditions A to D.

As shown in FIG. 9, the axis of abscissa (A, B, C, and D) represents the constituent elements (experimental conditions) of the substrate holding apparatus 200. More specifically, in each condition, one of the number of gas outlets (on the inner peripheral side) 123a, the number of gas outlets (on the outer peripheral side) 125a, and choice between an ordinary flat disk-like (even) heat-conductive sheet 107′ and recessed heat-conductive sheet 107 is changed. The axis of ordinate represents the substrate temperature distribution measured by the thermocouples 101 under each of the respective conditions (A, B, C, and D).

According to the condition A (comparative example), a flat disk-like heat-conductive sheet 107′ having three gas outlets (on the inner peripheral side) 123a and no gas outlet (on the outer peripheral side) 125a is employed.

According to the condition B (comparative example), a flat disk-like heat-conductive sheet 107′ having four gas outlets (on the inner peripheral side) 123a and 12 gas outlets (on the outer peripheral side) 125a is employed.

According to the condition C (comparative example), a flat disk-like heat-conductive sheet 107′ having no gas outlet (on the inner peripheral side) 123a and 12 gas outlets (on the outer peripheral side) 125a is employed.

According to the condition D (embodiment), a recessed heat-conductive sheet 107 having no gas outlet (on the inner peripheral side) 123a and 12 gas outlets (on the outer peripheral side) 125a is employed.

In the experimental result of FIG. 9, the temperature distribution of the condition A was 400° C.±8° C., that of the condition B was 400° C.±11° C., and that of the condition C was 400° C.±7.7° C. In contrast to this, the condition D of this embodiment provided the most uniform substrate temperature distribution (400° C.±4.1° C.).

The conditions A and C as comparative examples were compared. When the positions of the inert gas inlet ports were changed from the inner peripheral side to the outer peripheral side, the temperature distribution improved by 0.3° C.

Regarding the condition C and condition D as the comparative example and the embodiment, respectively, which were different only in the structure of the heat-conductive sheet, the substrate temperature distribution of the condition C was 400° C.±7.7° C., whereas that of the condition D was 400° C.±4.1° C. Namely, when the heat-conductive sheet having a recessed inner peripheral portion was used in place of the flat disk-like heat-conductive sheet, the temperature distribution improved by 3.6° C.

From the above experimental result, when a heat-conductive sheet with a recessed inner peripheral portion interposes between the electrostatic chucking plate 105 and heater unit 133, variations in substrate temperature distribution reduce greatly.

[Arrangement of Gas Channel]

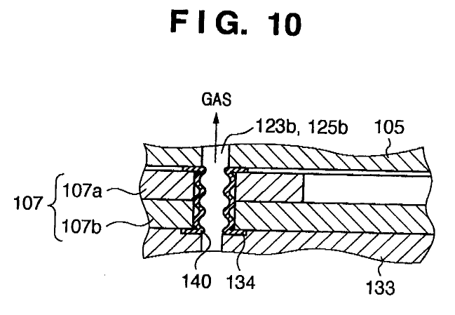

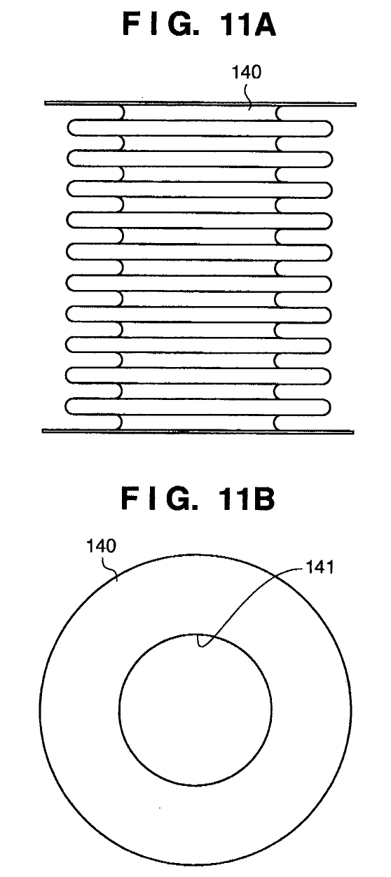

FIG. 10 is an enlarged view of the gas channel 125b formed in the heat-conductive sheet 107 in FIG. 4A. FIG. 11A is a plan view of a microbellows in FIG. 10, and FIG. 11B is a side view of the microbellows in FIG. 10. As shown in FIG. 10 and FIGS. 11A and 11B, a microbellows 140 as an elastic member is disposed on the inner wall portion of a gas channel 123b or of the gas channel 125b formed in the heat-conductive sheet 107. The microbellows 140 is a cylindrical metal bellows member stretchable in the direction of height in FIG. 10. The microbellows 140 can be formed by electrodepositing a high-refractory metal, for example, nickel (Ni). The material to form the microbellows 140 is not limited to a refractory metal, but synthetic rubber, a synthetic resin, or the like can be employed. If the microbellows 140 is to be used under a high temperature, it is preferably made of a metal.

The microbellows 140 is formed to be larger in the direction of height than the thickness D2 as the total thickness of the heat-conductive sheet portions 107a and 107b stacked together. The microbellows 140 is disposed in an elastically deformed (contracted) state on the inner wall portion of each of the gas channels 123b and 125b. A hollow portion 141 of the microbellows 140 allows the heater unit 133 to communicate with the electrostatic chucking plate 105 and constitutes part of each of the gas channels 123b and 125b. A spot facing hole 134 is formed in part of the heater unit 133 where an end of the microbellows 140 is located. The end of the microbellows 140 is fitted in the spot facing hole 134 by caulking.

The elastic member need not be a bellows member such as the microbellows 140, but can be a cylindrical leaf spring or the like. The elastic member need not have an elastic force that can generate a pressure sufficient to seal the inert gas, but suffices as far as it can conform to a change (deformation of the heat-conductive sheet 107) in the gap between the heater unit 133 and electrostatic chucking plate 105. To conform better to a change in the gap between the heater unit 133 and electrostatic chucking plate 105, the elastic member preferably has a smaller elastic coefficient than that of the heat-conductive sheet 107.

### INDUSTRIAL APPLICABILITY

The substrate holding apparatus according to the present invention can also be employed if it is to be disposed in the process chamber of a plasma processing apparatus such as a sputtering apparatus, dry etching apparatus, plasma asher apparatus, CVD apparatus, or liquid crystal display manufacturing apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-129118 filed May 16, 2008, and No. 2009-038453 filed Feb. 20, 2009, which are hereby incorporated by reference herein in their entireties.

What is claimed is:

1. A substrate holding apparatus comprising:
a substrate holding mechanism configured to hold a substrate;
a heating mechanism; and
a heat-conductive member which is interposed between said substrate holding mechanism and said heating mechanism to be in contact therewith and conducts heat generated by said heating mechanism to said substrate holding mechanism,
wherein said heat-conductive member has a recessed section that opens to the substrate.

2. The apparatus according to claim 1, wherein a plurality of elastic locking members fix an outer edge of said substrate holding mechanism to said heating mechanism.

3. The apparatus according to one of claim 1, wherein said substrate holding mechanism chucks and holds the substrate by an electrostatic force.

4. The apparatus according to claim 1, wherein said heat-conductive member is formed by stacking a ring-like sheet portion with a center bored on a disk-like sheet portion and includes a projection on an outer peripheral portion thereof and a recess on an inner peripheral portion thereof.

5. The apparatus according to claims 1, wherein said heat-conductive member is formed by stacking a frame-like sheet portion with a center bored on a rectangular sheet portion and includes a projection on an outer edge thereof and a recess at a center thereof.

6. The apparatus according to claim 4, wherein
said substrate holding mechanism is provided with a recessed groove, in an upper surface thereof, which forms a space with respect to a lower surface of the substrate when the substrate is placed, and
the projection on the outer peripheral portion of said heat-conductive member includes a gas channel which communicates with the recessed groove and supplies an inert gas to the space under the lower surface of the substrate.

7. The apparatus according to claim 6, wherein the recessed groove and the gas channel are formed on an outer peripheral side and/or a center of said substrate holding mechanism.

8. The apparatus according to claim 6, wherein a stretchable, elastic cylindrical member is formed on an inner wall portion of the gas channel.
